(19) United States
(12) Patent Application Publication
(10) Pub. No.: US 2025/0162001 A1
(43) Pub. Date: May 22, 2025

(54) System for Cleaning Gutters and Downspouts

(71) Applicant: Karl J. Patay, Westlake, OH (US)

(72) Inventor: Karl J. Patay, Westlake, OH (US)

(21) Appl. No.: 18/510,847

(22) Filed: Nov. 16, 2023

(51) Int. Cl. B08B 9/032; E04D 13/076

(52) U.S. Cl. CPC B08B 9/0328; E04D 13/0765; B08B 2209/032

(57) ABSTRACT

A system for cleaning a rain gutter and downspout, the downspout having an opening therein that is covered by a spring-biased door. A rain gutter having an opening in the bottom thereof communicates with the downspout through that opening and in standard fashion. A cap is placed within the gutter, over the opening in the bottom of the gutter. The cap has an arcuate member extending over the opening in the gutter, substantially parallel to and in line with the top of the gutter. The system includes an air blower in communication with a tube having an outlet nozzle assembly at the end of the tube. The outlet nozzle assembly is configured to accommodate receipt by both the rain gutter and the door covering the opening in the downspout. The outlet nozzle assembly receives an air stream from the tube connected to the air blower. When the outlet nozzle is placed into the gutter and moved there along, the airstream blows debris from the gutter and onto the ground. When the outlet nozzle makes entry into the downspout, through the door, the airstream blows upwardly and is directed by the curvate member of the cap into the gutter for subsequent removal therefrom.

### TECHNICAL FIELD

The invention herein resides in the art of cleaning and maintenance systems and devices. More particularly, the invention relates to a system for cleaning rain gutters and downspouts on buildings. Particularly, the invention relates to a system that accommodates the introduction of air blown into a rain gutter from ground level and to also make selected entry of air blown into a downspout, both for the purpose of removing debris and the like that would otherwise clog the gutter and/or downspout from effective use.

### BACKGROUND OF THE INVENTION

The use of rain gutters along the eaves of building roofs to gather water from the roof and pass it to a downspout is well known.

Gutters and downspouts are prone to clogging. Tree leaves, broken twigs and branches, acorns, and the like have a tendency to find their way into the gutter, and occasionally into the downspout itself, impeding the flow of rainwater from the roof surface to a sewer or cistern. Approaches for preventing this clogging are many, the most routine being climbing a ladder and manually removing the debris and clogs. That approach has inherent dangers, including falling off the ladder or having the ladder slip from under the individual. Other approaches include the implementation of screens or other shields that could be placed over the gutter, permanently or otherwise, to block the entry of debris and the like. However, these approaches are somewhat expensive and not totally effective. Moreover, their installation and maintenance typically involve climbing ladders.

There is a need in the art for a system that accommodates cleaning of gutters and downspouts from ground level, without the need for climbing ladders or the like.

There is a further need for a system for cleaning rain gutters and downspouts that is very cost effective, can accommodate the cleaning of both single-story and two-story buildings and is readily adaptable for implementation of presently existing rain gutter and downspout installations, with minimal modification, if any.

### SUMMARY OF INVENTION

In light of the foregoing, it is a first aspect of the invention to present a system for cleaning rain gutters and downspouts that eliminates the need for the use of ladders, climbing, or other dangerous activities.

Another aspect of the invention is the provision of a system for cleaning rain gutters and downspouts that requires minimal change, if any, to the gutter/downspout system being cleaned.

A further aspect of the invention is the provision of a system for cleaning rain gutters and downspouts that is readily implemented with state-of-the-art materials and techniques.

The foregoing and other aspects of the invention which may become apparent as detailed description proceeds are achieved by a system for cleaning a rain gutter and downspout, comprising: an air blower having a first outlet nozzle; a tube in air conducting communication with said first outlet nozzle at a first end thereof; and an outlet nozzle assembly at a second end of said tube, said outlet nozzle assembly comprising an air conduit having a first turn of 180° and a second turn of 90°.

The foregoing and additional aspects of the invention are achieved by a system for cleaning a rain gutter and downspout, comprising: a downspout having a first opening therein covered by a reciprocating door; a rain gutter having a second opening in a bottom surface thereof, said rain gutter being in communication with said downspout through said second opening; a cap received by said rain gutter over said second opening; an air blower; a tube in air conducting communication with said air blower; and an outlet nozzle assembly at an end of said tube, said outlet nozzle assembly being configured for air-blowing receipt by both said rain gutter and said reciprocating door to remove debris from clogging said rain gutter, downspout, and first opening.

### BRIEF DESCRIPTION OF THE DRAWINGS

For a complete understanding of the various aspects, structures, and techniques of the invention, reference should be made to the following detailed description and accompanying drawings, wherein:

FIG. 1 is a perspective view of a rain gutter cleaner according to the invention, including an extension tube adapted for implementation for second-story use;

FIG. 2 is a detailed perspective of an end of the blower tube of the rain gutter cleaner of FIG. 1;

FIG. 3 is a detailed perspective of the end of the blower tube of FIG. 2, rotated 90°;

FIG. 4 is a perspective view of the rain gutter cleaner of FIG. 1 showing the blower tube connected to the blower;

FIG. 5 is a detailed perspective view of the coupling between the blower tube and the blower of FIG. 1;

FIG. 6 is a perspective view of the extension tube of FIG. 1 for accommodating its implementation for two-story use;

FIG. 7 is a perspective view of a gutter cap employed for cleaning clogs and debris at the interconnection of a gutter and downspout;

FIG. 8 is a perspective view of a gutter and downspout interconnection employing the cap of FIG. 7 and a door assembly allowing access to the gutter;

FIG. 9 is a pictoral illustration of an individual employing the system of the invention to clean a gutter and downspout; and

FIGS. 10A and 10B are respectively front elevational and end views of a downspout nozzle of the invention.

### BEST MODE AND PREFERRED EMBODIMENTS

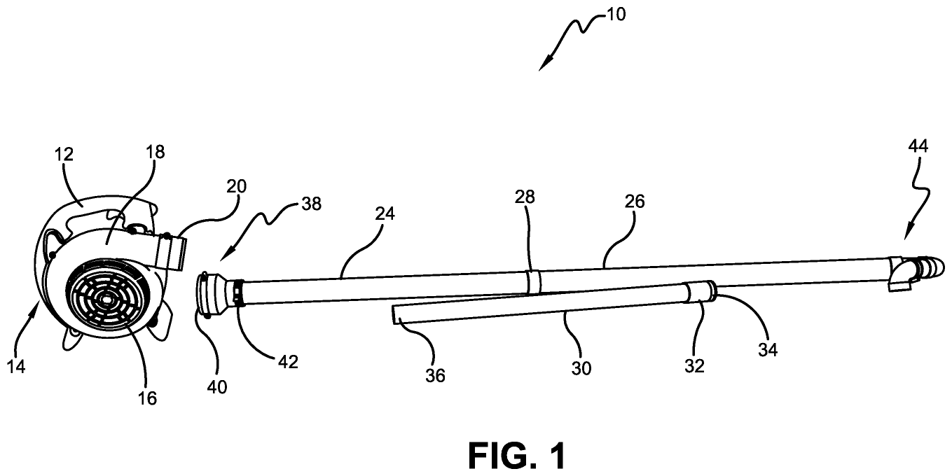

Referring now to the drawings and more particularly FIG. 1, it can be seen that a system for cleaning rain gutters and downspouts is designated generally by the numeral 10. The system 10 employs an air blower 12 of any suitable type, most typically referred to generically as a leaf blower. The air blower 12 is operated by a gas powered engine 14, although an electric motor may also be employed. A rotary fan assembly 16 is maintained within the air blower housing and is provided in air stream communication with a volute passage 18. Passage 18 extends to an outlet nozzle 20 of the air blower 12.

A tube 22 is shown as consisting of tube sections 24, 26, interconnected by a coupler 28. The tube sections 24, 26, may be permanently connected together through the coupler 28 by a plastic cement, or the like. Alternatively, another coupler 28 may accommodate the separations of the sections 24, 26, from each other.

According to the invention, the tube sections 24, 26, are generally of a length on the order of 4-5 feet, giving a reach of 8-10 feet from one end to the other, which is suited for reaching gutters of a single-story building or first floor eaves.

The invention also contemplates the use of the invention with taller buildings, such as two-story houses having the rain gutters positioned at the second floor. In such an instance, a tube section 30, again on the order of 4-5 feet in length, may be employed. A coupler 32 with an associated adjustable band clamp 34 is maintained at one end of the tube section 30, opposite the unmodified end 36. Implementation of the tube section 30 will be discussed below.

A rubber polymeric coupler/adapter 38 has an adjustable band clamp 40 on the larger end thereof. This accommodates the attachment and separation of the coupler/adapter 38 to the outlet nozzle 20 of the air blower 12. A second adjustable band clamp 42 is adapted for receipt and engagement of the tube section 24 to complete an air path from the volute passage 18 through the coupler/adapter 38, tube sections 24,26, and out of an adjustable outlet nozzle assembly 44.

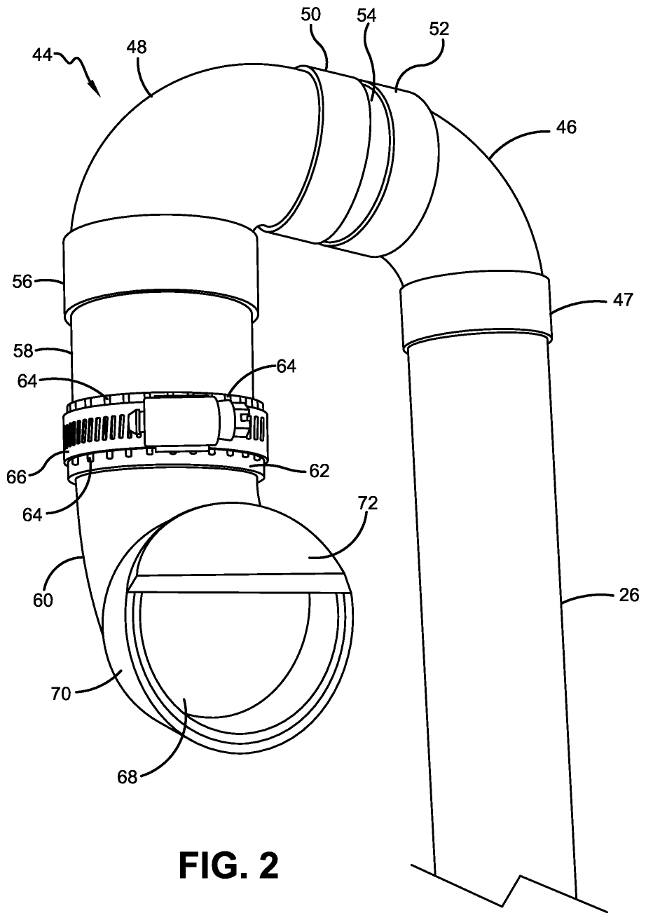

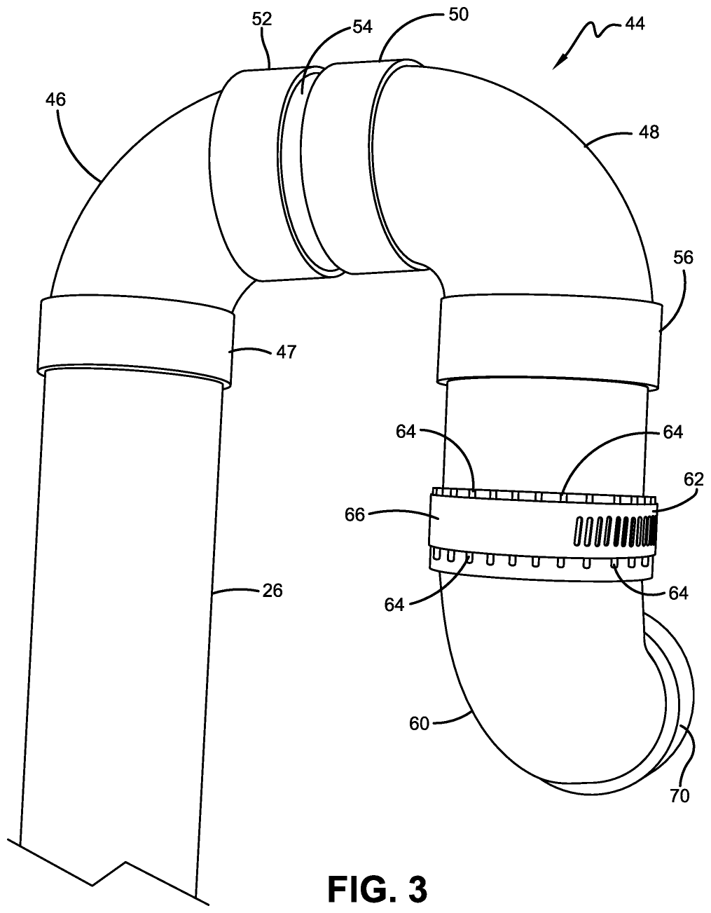

With reference now to FIGS. 2 and 3, the details of the adjustable outlet nozzle assembly 44 and tube section 26 can be appreciated. As shown, 900 elbow connectors 46, 48, configure a 1800 turn of the air passage from the tube section 26. A female connector 47, typically integral to the elbow 46, is preferably cemented to the tube section 26. Female couplers 50, 52, of respective ends of the elbows 46, 48, receive a short piece of male pipe 54, as shown. The length of the pipe section 54 is selected to accommodate the separation between the tube section 26 and the outlet nozzle of assembly 44. Such separation accommodates placement of the nozzle into a gutter, as will be discussed below.

A coupler 56 at an end of the elbow 48 receives a short length of pipe 58 by a plastic cement or the like. The pipe 58 is adapted to receive a 900 elbow 60 by means of the female coupler 62, having slots 64 therein to accommodate expansion to receive the pipe 58 and to be clamped thereto by the adjustable band clamp 66. The adjustable band clamp 66 allows for removal and adjustment of the position of the elbow 60 to optimize the position and orientation of the outlet 68 formed from the coupler 70. Alternatively, the elbow 60 may be cemented to the pipe 58 or molded integrally therewith if such adjustability is not required.

As shown, the outlet nozzle 68 is partially closed by a nozzle plate 70 at the top thereof. The plate 72 reduces the size of the nozzle opening 68 to effect an increase in the velocity of the air therefrom and to keep the air flow exiting the nozzle 68 near the bottom of the gutter to better lift debris, clogged material, and the like therefrom.

While the outlet nozzle assembly 44 has been shown and described as separate pieces interconnected by appropriate bonding or banding, it will be understood that such assembly may be of a single molded unit or molded units.

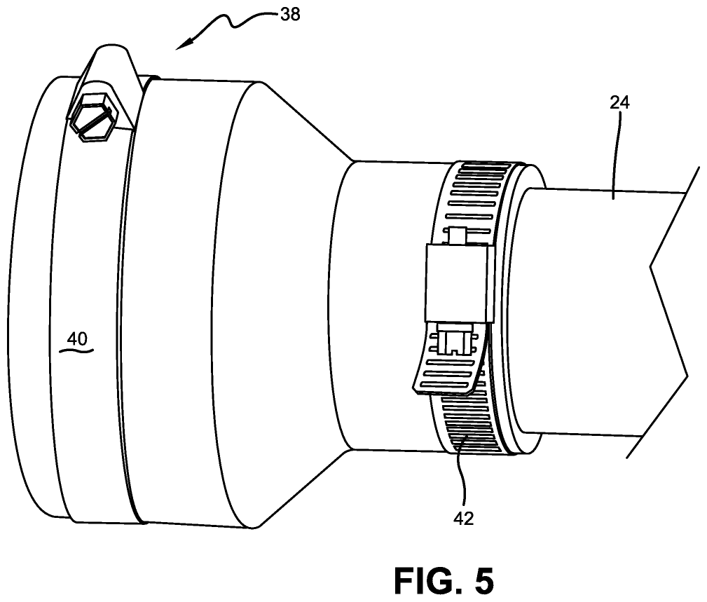

With reference now to FIG. 5, it can be seen that the coupler/adapter 38 is secured to tube section 24 by means of the adjustable band clamp 42 and is further adapted for connection to the outlet nozzle 20 of the air blower 12 by means of the adjustable band clamp 40.

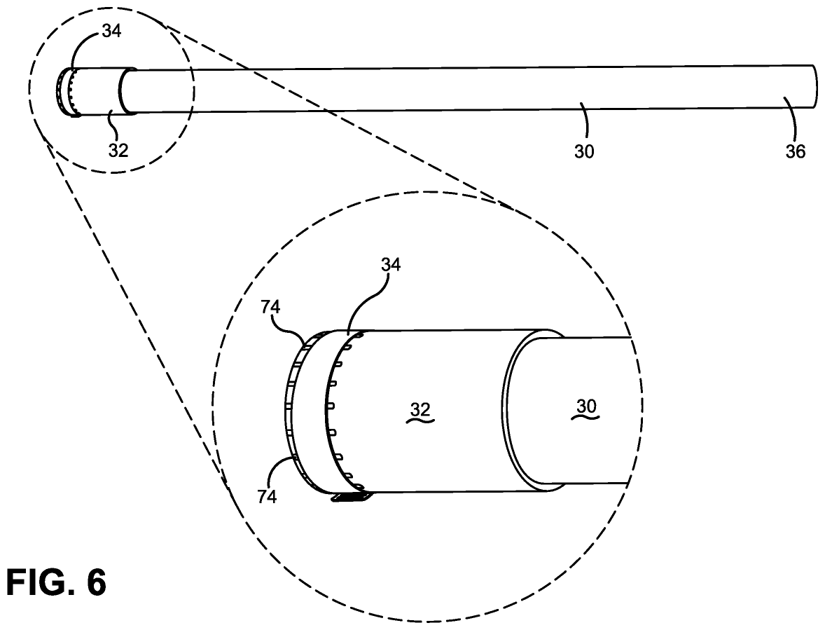

As shown in FIG. 6, the tube section 30, particularly adaptable for use on second-story gutters and the like, can be employed by separating the tube section 24 from the coupler/adapter 38, inserting the end 36 into the coupler/adapter 38, and securing it thereto by adjustable band clamp 42. The end of the tube section 24 that was removed from the coupler/adapter 38 may then be slid into the open end of the coupler 32 on the tube section 30. As shown, the end of the tube section 30 has a plurality of slots 32 passing therethrough about the end thereof. These slots 74 allow for flexibility while the end of the tube section 24 is slid within the coupler 32, which is cemented or otherwise fixedly attached to the tube section 30. When the tube section 24 is slid sufficiently within the coupler 32, as accommodated by the slots 74, the adjustable band clamp 34 is tightened to retain the tube section 24 therewithin. At that time, the system 10 is capable of accommodating gutters at, for example, the second story of a two-story home.

Alternatively to the use of tube section 30, the invention further contemplates that the tube 22 may be a telescopic tube, providing for adjustability of length to accommodate multiple stories.

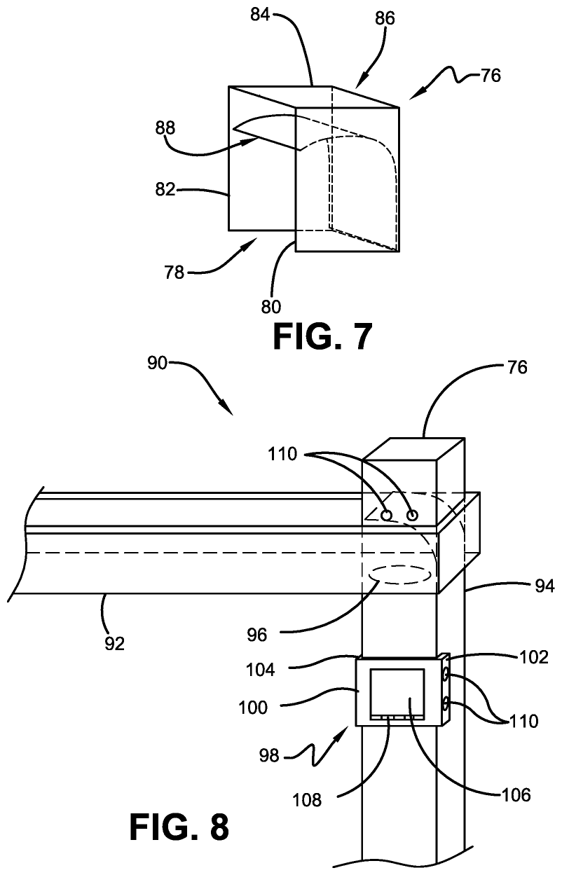

With reference now to FIGS. 7 and 8, it can be seen that a part of the system for cleaning rain gutters and downspouts 10, is the inclusion of a gutter cap 76 and a downspout door assembly 98.

With reference now to FIG. 7, it can be seen that a gutter cap implemented with the present invention is designated generally by the numeral 76. The gutter cap 76 is generally box-shaped, opened at the front and bottom as designated by the numeral 78. The remainder of the gutter cap 76 includes side walls 80, 82, a top 84 and a back 86, typically interconnected at right angels, as shown. A curvate member 88 extends from the bottom of the back wall 86 upwardly and outwardly to exit at the open front between the sides 80, 82. In a preferred embodiment, the curvate member extends in a slightly downward arc beneath the top 84 since the curvate member 88 defines an arcuate path vertically upwardly curved into a generally horizontal posture beneath the top 84 and then slightly downwardly as it extends to the open front 78. As will be appreciated below, the curvate number 88 serves to deflect debris and blown air from an upward movement from the bottom of the gutter cap 86 to a downwardly deflected outward movement at the open front thereof. In that regard, it is preferred that the top of the curvate member 88 is parallel to and in substantial alignment with the top of the gutter in which the cap 76 is received.

The gutter cap 76 may be made of any suitable material such as metallic or polymeric.

With reference now to FIG. 8, a gutter and downspout assembly made in accordance with the invention can be seen as designated generally by the numeral 90. The assembly includes a rain gutter 92, typically extending substantially horizontally along the drip edge of a roof line on the facia board and having a downspout 94 orthogonally extending downwardly therefrom into a receiving pipe or the like. An opening 96 is provided in the bottom of the rain gutter 92 and in direct communication with the interior of the downspout 94 to accommodate the passage of water from the roof, into the gutter, down the downspout, into an appropriate drainage area. A gutter cap 76 is positioned within the gutter 92 over the opening 96, typically at the end of the rain gutter 92. The gutter cap 76 may be affixed to the vertical sides of the rain gutter 92 by appropriate sheet metal screws 110, or the like. The curvate member 96 extends back towards the rain gutter 92 with a slight downward deflection, as discussed above.

A door assembly 98 consists of a face plate 100, side flanges 102, 104, a door 106 and spring-biased door hinge 108. The door assembly 98 is used to accommodate access to the interior passage of the downspout 94. In this regard, an opening is cut into the face of the downspout 94 that is dimensioned to accommodate deflection of the door 106 through the opening and toward the back wall of the downspout 94 to accommodate insertion of the outlet nozzle 98 of the nozzle assembly 44 to enter therein for the passage of forceful air upwardly. This cleans out any debris received by or clogging the opening 96, which debris is then deflected by the curvate member outwardly and slightly downwardly of the gutter cap 76. A spring biased door hinge 108 allows the door 106 to return to its normally closed and sealed position upon removal of the outlet nozzle assembly 44.

The door assembly 98 is fixedly attached to the downspout 94 by means of self-tapping sheet metal screws 110 or the like. The door assembly 98 may also be made of any suitable material such as metallic or polymeric materials.

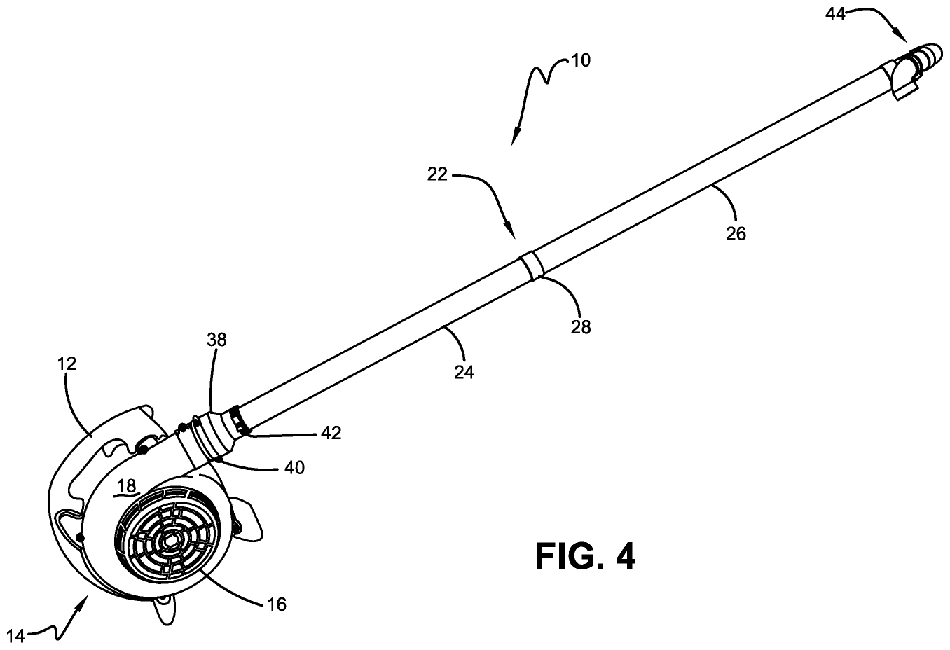

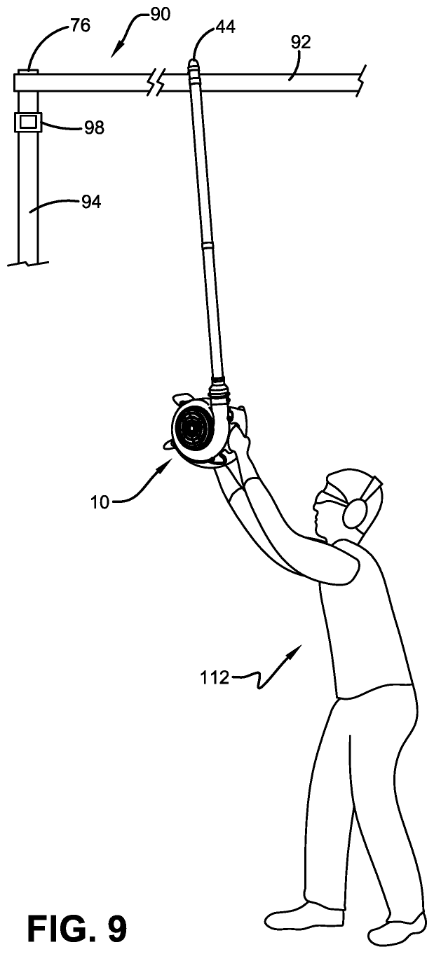

With reference now to FIG. 9, it should be appreciated that an operator may employ the system for cleaning rain gutters and downspouts as shown and described. An individual will typically begin with the system 10 as shown in FIG. 4. Of course, if second-story gutters are to be cleaned, the tube section 30 will also be employed to extend the reach of the tubular sections, as described above. The outlet nozzle 68, as shown in FIG. 2, may then be lifted over the outer edge of the rain gutter 92 and the unit angled downwardly to direct air from the nozzle 68 into the rain gutter as the individual walks along the length of the gutter, blowing debris therefrom. The separation area between the tube 26 and the pipe 58 and 90° elbow 60 is the area that receives the front face of the rain gutter as the individual walks there along.

To remove any debris, clogs, or the like, from the end of the gutter, as at the opening 96, the coupler 70 of the nozzle 68 may be pushed against the door 106 of the door assembly 98 to allow powered air from the air blower 12 to pass upwardly through the downspout 94, out of the opening 96, and thence downwardly by the curvate member 88.

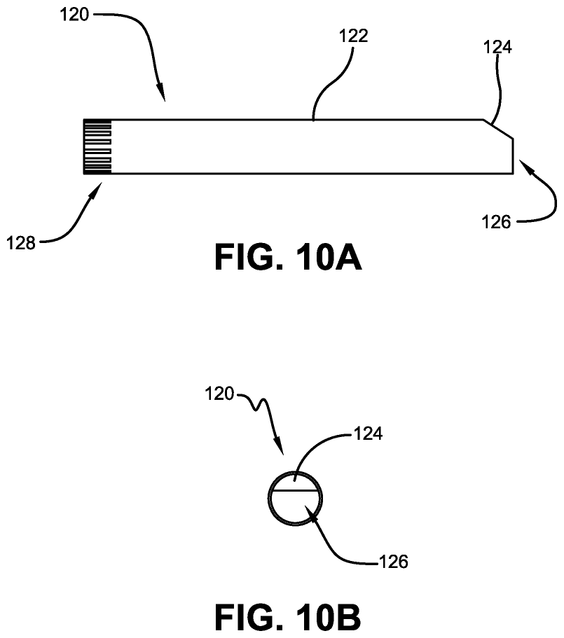

As presented above, the door assembly 98 is positioned in an upper portion of the downspout 94 in contemplation that most clogging of the rain gutter/downspout assembly occurs near the opening 96. Also, as presented above, access to spring-biased door 106 can often be made by contact with the nozzle assembly 44. However, the invention contemplates placement of the window assembly 98 at various positions along the length of the downspout, from that shown in FIG. 8 to the downspout outlet near ground level. Accordingly, the invention further contemplates the implementation and use of a downspout nozzle 120, best shown in FIGS. 10A and 10B, and designated generally by 120. The downspout nozzle 120 is a tubular member 122, having a plate 124 at an outlet end thereof, the plate 124 being placed on a bias as shown in FIG. 10A, giving partial closure to the outlet orifice 126. Such is similar to that of the outlet nozzle 68 of the nozzle assembly 44. The inlet end 128 of the tubular member 122 is fluted, as shown, to accommodate the various uses presented directly below.

When the door assembly 98 is placed in the downspout 94 near the top of the downspout, as shown in FIG. 8, the downspout nozzle 120 may be employed by attachment to the outlet nozzle assembly 44 by means of an appropriate band clamp over the coupler 70 to allow communication between the outlet nozzle 68 and the outlet orifice 126. The tubular member, being of a length on the order of 1 foot, allows for ease of use in opening the door 106 without being impeded by contact with the gutter or downspout.

When the window 96 is mounted midway down the downspout 94, a different implementation of the downspout nozzle 120 is employed. In this situation, the tube 22 is removed from the coupler 38 and the end 36 of the tube section 30 may be inserted and clamped by means of the band clamp 42. The downspout nozzle 120 may then be attached at the opposite end of the tube 30 by means of the coupler 32 and band clamp 34. The tube 30 accommodates access to the door assembly 98 in a mid-range of elevation and where access may be at a distance due to the presence of bushes or other vegetation.

Finally, when the door assembly 98 is positioned near the bottom of the downspout 94, the downspout nozzle 120 may be connected directly to the air blower 12 by means of the coupler/adapter 38 and secured engagement as by band clamp 42.

Thus it can be seen that the various aspects of the invention have been achieved by using the system presented and described above. While in accordance with patent statutes only the best mode and preferred embodiment of the invention has been presented and described in detail, the invention is not limited thereto or thereby. Accordingly, for an appreciation of the true scope and breadth of the invention, reference should be made to the following claims.

What is claimed is:

1. A system for cleaning a rain gutter and downspout, comprising:
an air blower having a first outlet nozzle;
a tube in air conducting communication with said first outlet nozzle at a first end thereof; and
an outlet nozzle assembly at a second end of said tube, said outlet nozzle assembly comprising an air conduit having a first turn of 180° and a second turn of 90°.

2. The system for cleaning a rain gutter and downspout as recited in claim 1, wherein said first turn and said tube lie in a same plane.

3. The system for cleaning a rain gutter and downspout as recited in claim 2, wherein said second turn is orthogonal to said first turn.

4. The system for cleaning a rain gutter and downspout as recited in claim 3, wherein said nozzle outlet assembly further comprises a second outlet nozzle having an orifice substantially circular in nature.

5. The system for cleaning a rain gutter and downspout as recited in claim 4, wherein said second outlet nozzle is closed by a plate at a top portion thereof, decreasing a size of said orifice.

6. The system for cleaning a rain gutter and downspout as recited in claim 5, wherein said outlet nozzle assembly is of unitary construction.

7. The system for cleaning a rain gutter and downspout as recited in claim 1, wherein said tube is extendable.

8. The system for cleaning a rain gutter and downspout as recited in claim 7, wherein said tube is telescopic.

9. The system for cleaning a rain gutter and downspout as recited in claim 7, further comprising an extension tube section selectively interposed between said tube and said first outlet nozzle.

10. The system for cleaning a rain gutter and downspout as recited in claim 1, further comprising a cap received by the rain gutter over an opening in the rain gutter in communication with the downspout, said cap having a curvate member over the opening and extending toward the gutter.

11. The system for cleaning a rain gutter and downspout as recited in claim 10, further comprising a door assembly mounted over an opening in the downspout, said door assembly comprising a spring biased door adapted to be urged inwardly by said second outlet nozzle to allow forced air entry into the downspout upwardly, through the opening in the rain gutter and deflected into said gutter by said curvate member.

12. The system for cleaning a rain gutter and downspout as recited in claim 11, further comprising a downspout nozzle adapted for attachment to said second outlet nozzle, said downspout nozzle extending the effective length of said second outlet nozzle.

13. The system for cleaning a rain gutter and downspout as recited in claim 11, wherein a door of said door assembly is hinged at the bottom thereof.

14. A system for cleaning a rain gutter and downspout, comprising:
a downspout having a first opening therein covered by a reciprocating door;
a rain gutter having a second opening in a bottom surface thereof, said rain gutter being in communication with said downspout through said second opening;
a cap received by said rain gutter over said second opening;
an air blower;
a tube in air conducting communication with said air blower;
an outlet nozzle assembly at an end of said tube, said outlet nozzle assembly being configured for air-blowing receipt by both said rain gutter and said reciprocating door to remove debris from clogging said rain gutter, downspout, and first opening.

15. The system for cleaning a rain gutter and downspout as recited in claim 14, wherein said cap has a curvate member over said second opening extending toward said gutter.

16. The system for cleaning a rain gutter and downspout as recited in claim 15, wherein said reciprocating door is hinged at a bottom thereof in a normally closed position, adapted for opening by said outlet nozzle assembly.

17. The system for cleaning a rain gutter and downspout as recited in claim 16, wherein said door is spring biased closed.

18. The system for cleaning a rain gutter and downspout as recited in claim 14, wherein said outlet nozzle assembly is shaped as an inverted U adapted for receipt over an outer edge of said rain gutter and having a nozzle extending orthogonally from a leg of said U shape.

19. The system for cleaning a rain gutter and downspout as recited in claim 18, wherein said orthogonally extending nozzle is adapted for opening engagement with said door.
